(19) United States
(12) Patent Application Publication
(10) Pub. No.: US 2025/0116788 A1
(43) Pub. Date: Apr. 10, 2025

(54) Methods and Apparatus for Processing a Counting Output

(71) Applicant: Tracerco Limited, London (GB)

(72) Inventors: Philip Davies, Billingham (GB); David James Fitzgerald, Billingham (GB); Andrew James O'Malley, Billingham (GB); Claire Watson, Billingham (GB)

(73) Assignee: Tracerco Limited, London (GB)

(21) Appl. No.: 18/846,558

(22) PCT Filed: Dec. 7, 2022
(86) PCT No.: PCT/GB2022/053116

§ 371 Date: Sep. 12, 2024

(30) Foreign Application Priority Data
Mar. 15, 2022 (GB) 2203570.3

(51) Int. Cl. G01T 1/17; G01T 1/18

(52) U.S. Cl. CPC G01T 1/17; G01T 1/18

(57) ABSTRACT

A method of processing a counting output associated with a counting device comprising: (i) calculating a first time-to-count average value based on time-to-count values obtained for a number of events ‘n’ between events x1 and xn; (ii) measuring a time-to-count value associated with event xn+1; and (iii) calculating a second time-to-count average value based on time-to-count values obtained for the number of events ‘n’ between events x2 and xn+1.

### FIELD

The present disclosure relates to methods and apparatus for processing a counting output associated with a counting device. In particular, but not exclusively, the present invention relates to methods and apparatus for processing a counting output associated with a radiation detection device such as a Geiger-Müller tube.

### BACKGROUND

Radiation detection devices, e.g. radiation dosimeters, are a type of electronic device that measures the level of exposure (dose) to an external source of ionizing radiation. Radiation dosimeters are therefore typically used to monitor and/or record a dose and/or a dose rate of radiation in a given environment. This may be for continuous monitoring in a specific location. Alternatively, this may be for monitoring the potential exposure to ionising radiation by a person, in which case the dosimeter may typically be worn by the person being monitored. Such a device is commonly known as an electronic personal dosimeter. Electronic personal dosimeters typically provide a continuous readout of cumulative dose and/or instant dose rate and are often equipped with a warning element that can provide a user with a signal (such as an audible sound or a visual display) if a predetermined cumulative dose or dose rate is exceeded.

Electronic personal dosimeters are battery-powered, and typically use either a small Geiger-Müller (GM) tube or a semiconductor (Si chip) in which ionizing radiation releases charges result in measurable electric current. Examples of such devices include the Tracerco™ Personal Electronic Dosimeters.

In a Geiger-Müller tube, the GM tube includes a chamber filled with a noble gas or halogen and a quench gas or vapour such as a hydrocarbon. The chamber is equipped with two electrodes that apply a potential difference of several hundred volts within the chamber. When an ionizing radiation hits the tube, the gas within the chamber is ionized by the incident radiation, which creates charged particles in the chamber. The electric field created by the voltage between the electrodes allows the created charge to move within the chamber, and the resulting electrical pulse is measured using electronics within the instrument.

A problem with radiation detectors using GM tubes is that, under application of a continuous voltage, after each ionising event, the tube takes a certain amount of time to charge up between pulses and be ready to count a subsequent event (as it is essentially a capacitor being charged via a large value resistor). This is commonly known as “dead time”. The actual dead time depends on several factors including the active volume and shape of the detector, making it difficult to correct for. This dead time can result in saturation of the GM tube, thus resulting in underreporting the event rate, particularly in higher radiation environments.

Certain studies (see T. J. Lewis, GEIGER-COUNTER OPERATION WITHOUT DEAD-TIME, Appl. sci. Res., 1955, Section B, Vol 5, Queen Mary College, London) have suggested that it may be theoretically possible to switch a Geiger-Müller (GM) tube on and off in order to remove dead time effects and increase count rate measurement. This “time-to-count” approach is independent of dead time and limits the number of discharges in high radiation fields by introducing a fixed wait time between discharges, i.e., operating the counter with a pulsed voltage. The wait time is chosen to be longer than the recovery time of the tube. However, to date, no practical technical means of implementing this theoretical principle in an effective and reliable manner have been disclosed.

As mentioned above, in a Geiger-Müller tube, the GM tube includes a chamber filled with a halogen gas and quenching medium, and the chamber is equipped with two electrodes (an anode and a cathode) that apply a potential difference of several hundred volts within the chamber. Typically, in order to “charge” the tube, the voltage at the anode is increased to its target value (e.g. 550-600V). The cathode is typically at a 0V potential. The anode voltage is typically generated by passing a current through a very high value resistor at the anode, in order to prevent or limit the risk of arcing between the electrodes upon ionisation. However, there are a number of drawbacks associated with this conventional set-up. First, there is a “dead time” following an ionisation event (a discharge caused by incident radiation) which is a combination of two effects: (i) the time taken for the multiple electron avalanches to terminate; and (ii) it takes a finite amount of time for the tube to charge back up to its full voltage, due to the large current-limiting resistor at the anode, during which the probability of the GM Tube detecting radiation is reduced. Furthermore, the voltage is typically applied continuously whilst the tube is charged until an ionizing event is detected, which is power-intensive at higher count rates.

The generation of ionizing radiation and its detection is assumed to be produced according to a statistically independent, random process characterized by a constant probability of occurrence per unit time, also known as a Poisson random process. The Poisson probability is given by the formula:

$$p ( next event occuring in dt after delay t ) = P ( 0 events during time 0 to t ) \times P ( event during dt )$$

$$p ( t ) = P ( 0 ) \times rdt$$

$$p ( t ) = {( r t )}^{0} {e}^{- r t} / 0 ! \times rdt$$

$$p ( t ) = {e}^{- r t} \times rdt$$

$$d p ( t ) / dt = r {e}^{- r t}$$

where P is the Poisson probability, k is the number of events, t is the time, and r is the average rate of occurrence.

A distribution function can be derived to describe the time intervals between adjacent random events. The differential probability dp of the occurrence of an event within a differential time interval dt is r.dt, where r is the average rate of occurrence. Then for a finite time interval T, the average number of events occurring is rT.

In order to derive a distribution function to describe the time intervals between successive random events, an event is assumed to have occurred at time t=0. In order to determine the differential probability that the next event will take place within a differential time dt after a time interval of length t, two independent processes must take place: (i) no events may occur within the time interval from 0 to t; and (ii) an event must take place in the next differential time increment dt. The overall probability will then be given by the product of the probabilities characterizing the two processes:

$$p ( next event occuring in dt after delay t ) = P ( 0 events during time 0 to t ) \times P ( event during dt )$$

$$p ( t ) = P ( 0 ) \times rdt$$

$$p ( t ) = {( r t )}^{0} {e}^{- r t} / 0 ! \times rdt$$

$$p ( t ) = {e}^{- r t} \times rdt$$

$$d p ( t ) / dt = r {e}^{- r t}$$

where p (t) is the function describing the distribution of intervals between successive random events.

The average time-to-count length is given by:

$$\overline{t} = {\int }_{0}^{∞} t \times p ( t ) dt / {\int }_{0}^{∞} p ( t ) dt = 1 / r$$

As with all measurements, there are statistical uncertainties associated with averaging time-to-count measurements. Due to the random characteristic of a Poisson random process (such as radiation), the confidence level that any one given measurement accurately represents the true average event rate is low. Therefore, in order to meet the requirements set out in the standards for dosimeters, many measurements must be taken and averaged over. Whilst an accurate estimation for the event rate may be relatively easy to achieve in a radiation field where the event rate is high, this is significantly more challenging at low event rates because the time-to-count values will be larger and therefore it will take longer to collect a suitable number of events to average over.

For example, let us consider a radiation dose rate incident on a radiation measuring device which results in a count rate of 10⁴ radiation field of 10⁴ counts/second (“counts per second” or “cps”). Placing a shield between the radiation source and the device would lower exposure, for example to 1 cps. Typically, the count rate is taken as an average (mean) value over a fixed number of time-to-count values, which for the purpose of this example may be 30. As a result, following the change of irradiation field from 10⁴ cps to 1 cps, it would take approximately 30 s for 30 counts to be registered in this new radiation field. Thus, if the fixed number of time-to-count values used to calculate the average was 30, it would take about 30 s for the device to display the count rate change from 10⁴ cps to 1 cps as it would take approximately 30 s for 30 counts to be registered in this new radiation field. This would not meet the required standards.

It is an object of the present invention to address or mitigate one or more problems associated with the prior art.

### SUMMARY

The present inventors have developed systems and methods configured to process a counting output associated with a counting device such as a Geiger-Müller tube. The new approach allows a user to measure an event rate with quicker response times at a higher range. This will allow compliance with the requirements set out in the standards for dosimeters, even at very low count rates (e.g. when the count rate tends to zero) and/or upon a rapid step change from high to low count rates.

According to a first aspect of the present specification, there is provided a method of processing a counting output associated with a counting device, the method comprising:
calculating a first time-to-count average value based on time-to-count values obtained for a number of events ‘n’ between events x₁ and xₙ;
measuring a time-to-count value associated with event xₙ₊₁; and calculating a second time-to-count average value based on time-to-count values obtained for the number of events ‘n’ between events x₂ and xₙ₊₁.

Thus, the second time-to-count average value, and any subsequent time-to-count average value calculated for a number of events ‘n’ including any subsequent time-to-count value, can be considered a “rolling” average based on the latest ‘n’ number of events.

An average count rate, e.g. a first average count rate and/or a second average count rate, may be calculated based on an associated time-to-count average value, e.g. the first time-to-count average value or the second time-to-count average value. However, as mentioned above, if the time-to-count values increase significantly, e.g. compared to the time-to-count average value(s), the time required to detect an increase in the time-to-count average value over an epoch of interest, e.g. over the last ‘n’ number of events, may be significant. The present method addresses this problem by introducing “dummy counts” at a predetermined time interval “j” if no event has been registered after the predetermined time interval “j”. Thus, if no event has been registered after the predetermined time interval “j”, the method may comprise introducing a “dummy” time-to-count value equal to “j” associated with event xₙ₊₁. Thus, the term “event” will be herein understood, in the context of the present method, to relate either to a “real” event associated with a measured time-to-count value, or to a “dummy” event associated with a “dummy” time-to-count value, e.g. a “dummy” time-to-count value equal to “j”.

The method may comprise introducing a “dummy” time-to-count value equal to “j” associated with each subsequent event, until a count or “real” event is measured or registered. In such instance, the time value “j” is added to the “buffer” time-to-count when no real counts are measured. When a count or “real” event is measured or registered for event xₘ(m>n and xₘ>j), the method may comprise providing a time-to-count value corresponding to the measured time-to-count value associated with event xₘ. The time-to-count value corresponding to the measured time-to-count value associated with event xₘ may represent or may define an expected time-to-count value.

Subsequently, if no event is registered after the predetermined time interval “j”, the method may comprise introducing a “dummy” time-to-count value equal to the expected time-to-count value, e.g. equal to the measured time-to-count value associated with event xₘ. The method may comprise repeating this step until:
either a new count or “real” event is measured or registered; in which case the method may comprise providing a time-to-count value corresponding to the measured time-to-count value associated with the new count or “real” event; or
the expected time-to-count value has elapsed without a new count being measured or registered, in which case the method may comprise introducing a “dummy” time-to-count value equal to “j”.

The method may comprise repeating the above steps sequentially. Typically, the “dummy” time-to-count value “j” may be about 1 ms-500 ms, e.g. about 10 ms-200 ms, e.g. about 50 ms to 150 ms, e.g. about 100 ms.

Advantageously, the present method may help provide a quicker response to low count rates, e.g. to a sharp decrease or drop in the count rate, e.g. from a high dose rate to a low dose rate. It will be understood that, when used in connection with a radiation measuring device, the use of “dummy counts” only affects calculation of the instantaneous (average) count rate, but does not affect the overall accumulated dose measured by the device and the “dummy” counts are not taken into account in calculating accumulated dose. Although the introduction of “dummy counts” introduces a level of noise into the calculations, e.g. into the calculated “time-to-count” average value, it will be understood that the level of error introduced is acceptable at lower count rates (in line with standards requirements), and is outweighed by the benefit of a much faster response to a drop in count rates.

Typically, the counting device of the present specification may be a radiation detection apparatus. The counting device may comprise a Geiger-Müller tube. Furthermore, typically the method may be a computer-implemented method. The method may comprise processing the counting output using a smoothing algorithm. The method may comprise using a Non-Linear Exponential Smoothing (‘NLES’) algorithm.

As mentioned above, the method comprises:
calculating a first time-to-count average value based on time-to-count values obtained for a number of events ‘n’ between events x₁ and xₙ;
measuring a time-to-count value associated with event xₙ₊₁; and
calculating a second time-to-count average value based on time-to-count values obtained for the number of events ‘n’ between events x₂ and xₙ₊₁.

The method may comprise calculating an average count rate, e.g. a first average count rate and/or a second average count rate, based on an associated time-to-count average value, e.g. the first time-to-count average value or the second time-to-count average value. The method may comprise filtering the average count rate values.

The method may comprise applying an algorithm according to Formula (I):

$${S}_{n} = ( 1 / {t}_{n} - {S}_{n - 1} ) \times α ( \vert {Δ}_{n} \vert ) + {S}_{n - 1} ) \qquad ( I )$$

where Sₙ is the smoothed count rate value calculated by the algorithm,
tₙ is the current time-to-count average value, e.g. as calculated by the method of the first aspect,
Sₙ₋₁ is the previously smoothed count rate value calculated by the algorithm,

$${Δ}_{n} = \vert {log}_{10} {S}_{n - 1} - {log}_{10} 1 / {x}_{n} \vert ,$$

$$and$$

$$α ( \vert {Δ}_{n} \vert ) = \{ \begin{matrix}{α}_{0} , for \vert {Δ}_{n} \vert \leq {Δ}_{0} \\ \vert {Δ}_{n} \vert − {Δ}_{0} / {Δ}_{1} − {Δ}_{0} \times ( {α}_{1} − {α}_{0} ) + {α}_{0} , for {Δ}_{0} \leq \vert {Δ}_{n} \vert \leq {Δ}_{1} \\ {α}_{1} , for \vert {Δ}_{n} \vert \geq {Δ}_{1}\end{matrix}$$

wherein α₀ is a first filter applied when |Δₙ| is less than or equal to a first threshold Δ₀, and
α₁ is a second filter applied when |Δₙ| is equal to or greater than a second threshold Δ₁.

Thus, the value by which the current calculated value (e.g. time-to-count value or count rate value) should be smoothed may be a function of the difference between the current value and the previously smoothed value.

There may be provided a plurality of sets of filters. There may be provided two or more sets of filters, e.g. a first set of filters α₀ and α₁, and a second set of filters α′₀ and α′₁. The algorithm may apply or may use the first set of filters α₀ and α₁ under a first condition, e.g. when the calculated count rate, e.g. average count rate derived from a/the associated time-to-count average value, e.g. from the first time-to-count average value or the second time-to-count average value, is equal to or greater than a first threshold. The algorithm may apply or may use the second set of filters α′₀ and α′₁ under a second condition, e.g. when the calculated count rate, e.g. average count rate derived from a/the associated time-to-count average value, e.g. from the first time-to-count average value or the second time-to-count average value, is less than the first threshold. Advantageously, this may allow a smooth reading to be obtained at high count fields but allowing a quicker response to low count fields in response to smaller magnitude changes. The count rate threshold may be about 1-10 cps, e.g. about 2 cps.

The method may comprise displaying a signal representative of the counting output, typically count rate. The method may comprise displaying the smoothed count rate value. The method may comprise refreshing the display at a predetermined interval. The predetermined interval may be greater than the expected time-to-count value and/or than the “dummy” time-to-count value “j”. Advantageously, this may reduce the level of fluctuation in the displayed signal to a user. The predetermined interval may be 0.1-5 s, e.g. 0.5-2 s, e.g. about 1 s.

According to a second aspect of the present specification, there is provided a method of processing a counting output associated with a counting device, the method comprising:
calculating a first time-to-count average value based on time-to-count values obtained for a number of events ‘n’ between events x₁n and xₙ;
measuring a time-to-count value associated with event xₙ₊₁;
calculating a second time-to-count average value based on time-to-count values obtained for the number of events n between events x₂ and xₙ₊₁; and
applying an algorithm according to Formula (I) to calculate a smoothed count rate Sₙ:

$${S}_{n} = ( 1 / {t}_{n} - {S}_{n - 1} ) \times α ( \vert {Δ}_{n} \vert ) + {S}_{n - 1} ) \qquad ( I )$$

where Sₙ is the smoothed count rate value calculated by the algorithm;
tₙ is the second time-to-count average value,
Sₙ₋₁ is the previously smoothed count rate value calculated by the algorithm;

$${Δ}_{n} = \vert {log}_{10} {S}_{n - 1} - {log}_{10} 1 / {x}_{n} \vert ;$$

$$and$$

$$α ( \vert {Δ}_{n} \vert ) = \{ \begin{matrix}{α}_{0} , for \vert {Δ}_{n} \vert \leq {Δ}_{0} \\ \vert {Δ}_{n} \vert − {Δ}_{0} / {Δ}_{1} − {Δ}_{0} \times ( {α}_{1} − {α}_{0} ) + {α}_{0} , for {Δ}_{0} \leq \vert {Δ}_{n} \vert \leq {Δ}_{1} \\ {α}_{1} , for \vert {Δ}_{n} \vert \geq {Δ}_{1}\end{matrix}$$

wherein α₀ is a first filter applied when |Δₙ| is less than or equal to a first threshold Δ₀; and
   α₁ is a second filter applied when |Δₙ| is equal to or greater than a second threshold Δ₁.

Thus, the value by which the current calculated value (e.g. time-to-count value or count rate value) should be smoothed may be a function of the difference between the current value and the previously smoothed value.

There may be provided a plurality of sets of filters. There may be provided two or more sets of filters, e.g. a first set of filters α₀ and α₁, and a second set of filters α′₀ and α′₁. The algorithm may apply or may use the first set of filters α₀ and α₁ under a first condition, e.g. when the calculated count rate, e.g. average count rate derived from a/the associated time-to-count average value, e.g. from the first time-to-count average value or the second time-to-count average value, is equal to or greater than a first threshold. The algorithm may apply or may use the second set of filters α′₀ and α′₁ under a second condition, e.g. when the calculated count rate, e.g. average count rate derived from a/the associated time-to-count average value, e.g. from the first time-to-count average value or the second time-to-count average value, is less than the first threshold. Advantageously, this may allow a smooth reading to be obtained at high count fields but allowing a quicker response to low count fields in response to smaller magnitude changes. The count rate threshold may be about 1-10 cps, e.g. about 2 cps.

According to a third aspect of the present specification, there is provided a data processing apparatus comprising means for carrying out the method according to the first aspect or the second aspect. The data processing apparatus may comprise a processor configured to perform the method of the first aspect or second aspect.

According to a fourth aspect of the present specification, there is provided a computer program comprising instructions which, when the program is executed by a computer, cause the computer to carry out the method of the first aspect or the second aspect.

According to a fifth aspect of the present specification, there is provided a computer-readable medium comprising instructions which, when executed by a computer, cause the computer to carry out the method of the first aspect or second aspect.

The features described above in relation to the method according to the first aspect or second aspect are equally applicable in relation to the third, fourth or fifth aspects, and, merely for brevity, are not repeated here. The following features may apply equally to any of the previous aspects.

The counting device may comprise or may be a radiation detection apparatus. The counting device may comprise a Geiger-Müller tube. The radiation detection apparatus may comprise a Geiger-Müller tube comprising a chamber equipped with two or more electrodes, wherein the chamber is configured to be charged by temporarily connecting the two or more electrodes to their respective activation potential. The chamber may be provided with or may comprise a pair of electrodes, typically an anode and a cathode. The chamber may be configured to be charged by temporarily connecting the anode and the cathode to their respective activation potential. The activation potential of the anode may be in the range of about 300V-700V, e.g. about 440V-600V, typically about 550V. The activation potential of the cathode may be in the range of about 0V-50V, typically about 0V.

The anode may be maintained at a constant electric potential, e.g. at the anode activation potential. The apparatus may comprise a voltage supply unit configured to supply the anode activation potential. Advantageously, the anode may not comprise or may not be coupled to a resistor. The anode activation potential may not be determined by or may not be defined by a resistor. It will be understood that, when the voltage supply unit supplying the activation potential to the anode comprises a resistor, such a resistor may have an ohmic value sufficiently low such that the activation potential supplied by the voltage supply unit is not determined or defined by the resistor.

In conventional Geiger-Müller tubes, the anode voltage is typically generated by passing a current through a very high value resistor at the anode. This is generally required to minimise the risk of arcing between the electrodes upon ionisation. However, such an arrangement typically requires the voltage to be applied continuously whilst the G-M tube is activated and until an ionizing event is detected, which is power-intensive and still carries some risk of arcing. In addition, a non-negligeable amount of time is required for the tube to charge back up to its full voltage, due to the large current-limiting resistor at the anode, which reduced the maximum count rate that the system can detect.

In the present arrangement, the chamber is configured to be charged by temporarily connecting the two or more electrodes, e.g. anode and cathode, of the chamber to their respective activation potential, and then disconnecting at least one of the electrodes, typically the cathode, from its activation potential, until an ionizing event occurs. The inventors have discovered that, by using the intrinsic capacitive properties of the GM tube, a temporary activation of the tube is sufficient to charge the tube and maintain the tube in a charged or activated state for a sufficient amount of time until an ionizing event occurs. This provides a number of advantages:
First, when the gas in the GM tube is ionized, the tube discharges instantly because no potential differential is actively applied at the moment when ionization occurs. Thus, the risk of arcing may be eliminated or at least greatly reduced. This may also result in a faster system that may be capable of detecting higher count rates.
Second, the power required to maintain the tube charged may be reduced, particularly at high count rates. This is because, in the present system, the tube is charged at a predetermined time interval (typically 1 ms) following an ionisation event. Thus, at very high count rates, the number of times the tube can be charges will tend to 1000 times per second. In contrast, if powering the tube continuously, the maximum theoretical count rate would tend to 10⁶ times per second. Hence the current required to keep the tube charged can be reduced by a factor of up to 1000 in the present system.

The activation of the GM tube, e.g. connection of the cathode to its activation potential, may be performed for less than 1 ms, e.g. less than 100 μs, e.g. less than 10 μs, typically less than 5 μs. The activation of the GM tube may be performed for a period of about 10 ns-100 μs, e.g. about 100 ns-10 μs, typically about 500 ns-5 μs, e.g. between 500 ns and 2 μs. In an embodiment, the activation time may be about 1.2 μs. Thus, the activation time may be shorter than the/a typical or expected time-to-count value and/or may be shorter than a current pulse from the discharging of the tube.

The anode may be maintained at a constant electric potential, e.g. at its activation potential. The anode may be connected, e.g. permanently connected, to a voltage supply, e.g. via the voltage supply unit.

Advantageously, the cathode may be associated with a switch. The switch may be capable of connecting and disconnecting the cathode to its activating potential, e.g. about 0V. The switch may be provided within a cathode interface unit configured to activate and/or deactivate the cathode, e.g. configured to actuate the connection and disconnection of the cathode to its activation potential. The cathode switch may comprise or may be a transistor, preferably an N-type MOSFET (‘nFET’). Advantageously, this type of switch may provide a very fast means of activating the cathode, and thus of charging the GM tube. The apparatus may comprise a controller, e.g. a microcontroller unit (MCU), configured to control the anode voltage supply and/or the cathode interface unit, e.g. the switch. Preferably, the controller may be configured to control the anode voltage supply and the cathode interface unit.

There may be provided a controller for the radiation detection apparatus, the radiation detection apparatus comprising:
a Geiger-Müller tube comprising a chamber equipped with an anode and a cathode, wherein the chamber is configured to be charged by temporarily connecting the anode and the cathode to their respective activation potential;
a voltage supply unit configured to supply the anode activation potential; and
a cathode interface unit configured to actuate the connection and/or disconnection of the cathode to its activation potential,
wherein the controller is configured to control actuation of the anode voltage supply unit and of the cathode interface unit.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic diagram illustrating a radiation detection apparatus according to the prior art;

FIG. 2 illustrates the general principles of a “time-to-first-count” methodology;

FIGS. 3 to 5 show schematic diagrams illustrating a radiation detection apparatus suitable for use in the method according to the invention; and

FIG. 6 illustrates the principles of a “time-to-first-count” methodology implemented using the apparatus of FIGS. 3 to 5.

### DETAILED DESCRIPTION

As described in the summary section, the present specification provides systems and methods for controlling a Geiger-Müller tube, which allows for an increased range of detection of a radiation detection device, i.e. capable of operating at very high radiation fields whilst retaining sensitivity for low count rates. A number of more detailed examples are set out below to illustrate different embodiments of the present invention.

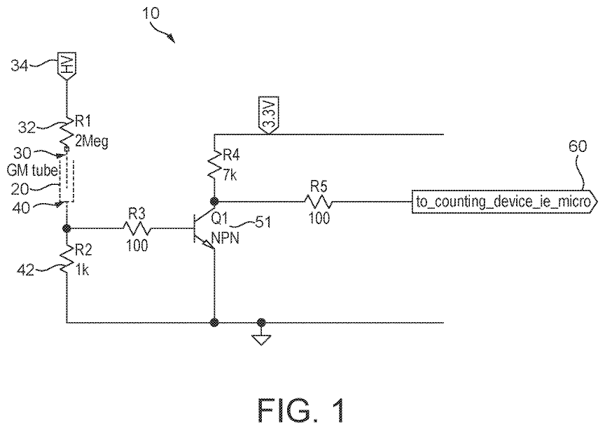

FIG. 1 shows a schematic diagram illustrating a radiation detection apparatus, generally designated 10, according to the prior art. The apparatus includes a GM tube 20 that includes a chamber filled with an inert gas and a quench gas or vapour. The chamber is equipped with two electrodes (an anode 30 and a cathode 40) that apply a potential difference of several hundred volts within the chamber. In this arrangement, the high voltage 34 at the anode is typically generated by passing a current through a very high value resistor 32 at the anode 30. This is required to minimise the risk of arcing between the electrodes upon ionization in the GM tube 20. However, such an arrangement typically requires the voltage to be applied continuously whilst the GM tube 20 is activated and until an ionizing event is detected, which is power-intensive and still carries some risk of arcing. In addition, a non-negligeable amount of time is required for the tube to charge back up to its full voltage, due to the large current-limiting resistor 32 at the anode, which causes a “dead time” during which the GM tube cannot detect radiation. Resistor 32 typically has a large value to provide the above properties, in this example 2MΩ.

At the cathode 40, resistor 42 will develop a voltage across it when current pulses flow through the GM tube, due to radiation, because Voltage=Current×Resistance. The brief pulse of voltage across resistor 42 will switch transistor 51 (or another amplifier element). This signal can then be connected to a counting device 60, such as a micro controller. By detecting the number of counts per second, the radiation “dose rate” can be calculated (Sieverts/Hour). The relationship between count rate and dose rate is approximately proportional.

As explained previously, a disadvantage of this method of operating the GM tube 20 is that it takes a finite time for the tube 20 to charge back up to 550V, due to the large current-limiting resistor 32. In addition, the gas in the GM tube 20 must have time to “quench” any free electrons prior to the next radiation event being detected. Such charging and quenching typically creates a “dead time” during which the GM tube 20 cannot detect radiation. This limits the maximum count rate that the detector can measure.

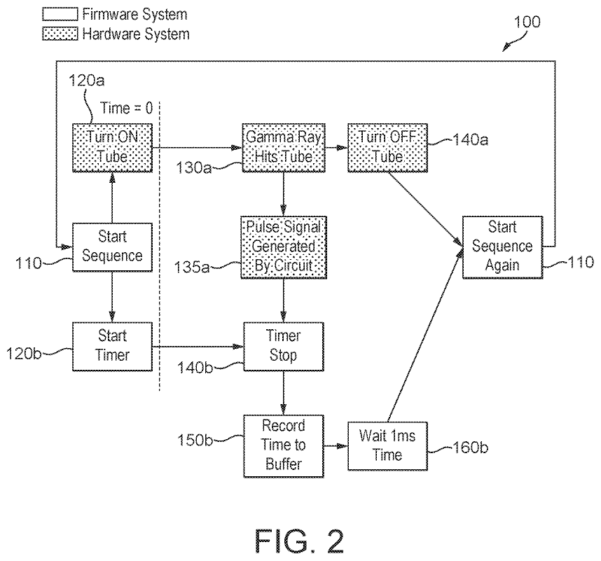

FIG. 2 illustrates the general principles of a “time-to-first-count” methodology. In such an approach, for example as suggested in T. J. Lewis (1955) discussed in the background section, a sequence is started 110 by simultaneously switching the GM tube on 120a and starting a timer 120b. In FIG. 2, the steps relating to hardware are provided with the suffix ‘a’ and the steps relating to firmware are provided with the suffix ‘b’. An ionisation event occurs when an ionising radiation hits the G-M tube 130a. This causes a pulse signal 135a to be generated within the circuit. This causes simultaneously the tube to be switched off 140a and the timer to stop 140b. The time required to buffer the system is then recorded 150b and a period of time longer than the dead time associated with the tube (for example 1 ms) must then elapse 160b before the next sequence can be started again 110. In this example the wait time 160b is chosen to be 1 ms, but it will be appreciated that the wait time may be selected so as to allow the tube to fall back to ground state, for example between about 50 μs and about 700 μs.

However, as explained previously, a difficulty with the approach described in T. J. Lewis (1955) is that the tube takes a non-negligible amount of time to reach its full target potential when switched on at the beginning of each cycle, which can introduce a timing error. This renders the implementation of this technique difficult or impractical.

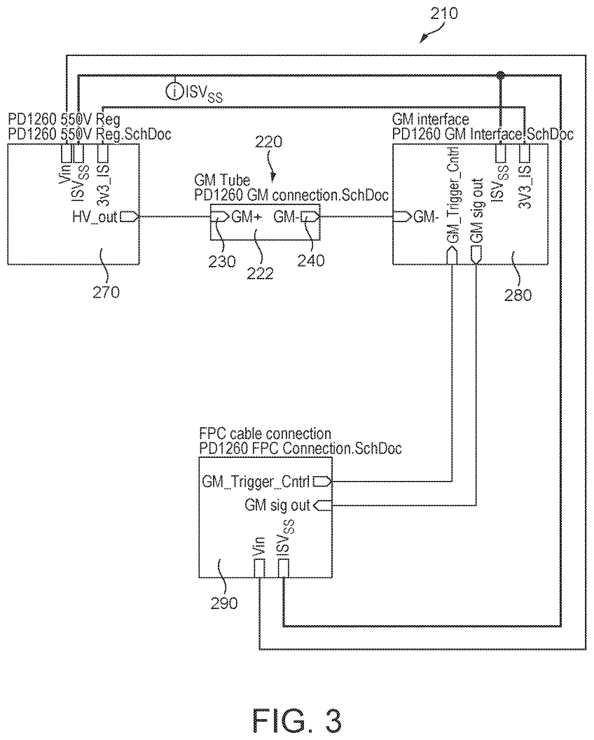

FIGS. 3 to 5 show schematic diagrams illustrating a radiation detection apparatus 210 suitable for use in the method according to the invention. Although significantly different, for ease of reference, the radiation detection apparatus 210 of FIG. 3 is generally similar to the radiation detection apparatus 10 of FIG. 1, like parts being denoted by like numerals, but incremented by ‘200’.

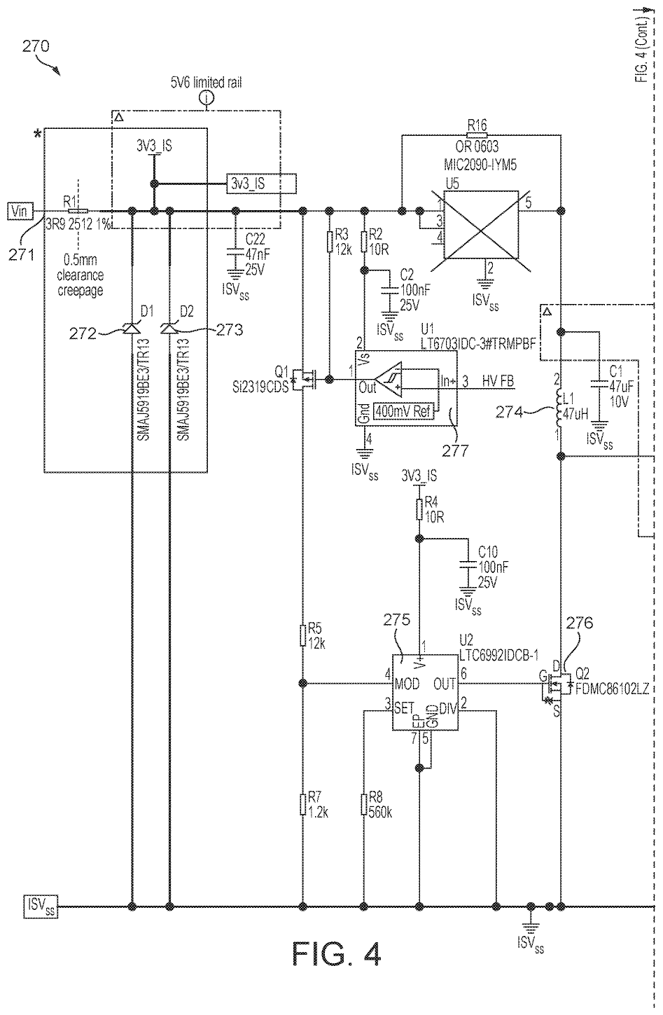

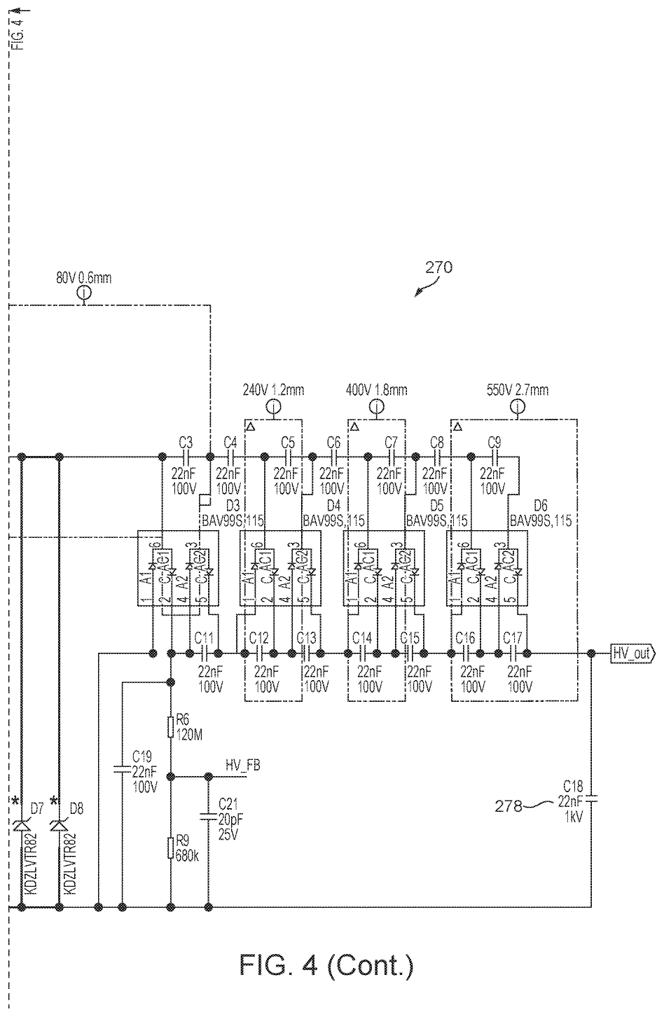

The radiation detection apparatus 210 includes a Geiger-Müller tube 220 comprising a chamber 222 equipped with an anode 230 and a cathode 240. In this embodiment, the GM tube circuit is designed for explosion-proof environments (Intrinsically Safe-referred to as “IS”) and non-IS applications. The anode 230 is powered by and is directed connected to a 550V supply unit 270 (described in more detail in FIG. 4) to place and/or maintain the anode in its activation potential. Thus, in contrast with the arrangement of FIG. 1, in the present arrangement, the anode 230 is not coupled to a resistor to provide the target activation potential, which may help reduce dead time.

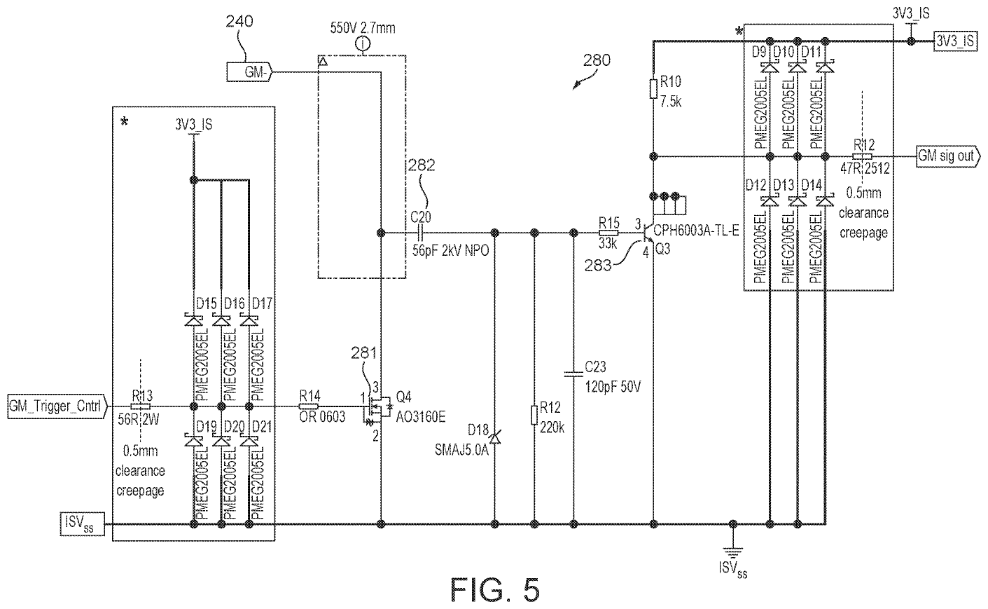

The cathode 240 is connected to an interface circuit 280 (described in more detail in FIG. 5). Both the supply unit 270 and the interface circuit 280 are connected to a Micro Controller Unit (MCU) 290, using pass-through current limiting connections to meet IS requirements. For IS applications, the entire module apparatus 210 may be potted (encapsulated), including the GM tube 220. For convenience, in the event of GM tube failure, a portion of the apparatus 210, such as a housing portion or casing, can be discarded and replaced with a replacement GM tube potted module, as a single unit.

With reference to FIG. 4, the supply unit 270 has a small resistor 271 which is only used to limit spark ignition currents, whilst diodes 272,273 limit the voltage that could be fed back from the high voltage (HV) supply. This is present for IS protection. Although the supply unit 270 includes a resistor 271, it will be understood that the ohmic value of the resistor 271 is small (in this example 3.9 Ω) such that the voltage supplied by the unit 270 is not determined or defined by the resistor 271 (in contrast to a conventional system).

There is provided a switched inductor 274, which forms the basis of a boost regulator. Switched inductor 274 generates approx. 80V transients. Switching is controlled by controller 275, which drives transistor 276. Controller 275 runs at a set frequency, defined by the set resistor. When the first stage of the charge pump reaches V>71V, comparator 277 switches off the supply to the MOD pin of controller 275, preventing further switching. The effect is that controller 275 only runs in order to “top up” the HV supply. In this example, seven charge pump stages are used to obtain 550V. Capacitor 278 holds the voltage for the GM tube and allows rapid recharging of the tube following an ionization event.

With reference to FIG. 5, the interface circuit 280 has a transistor 281 (Q4) which connects the GM tube cathode 240 to 0V. In this embodiment, the transistor 281 is an N-type MOSFET (‘nFET’). Advantageously, this type of transistor provides a very fast means of activating the cathode 240, and thus of charging the G-M tube 220.

Transistor 281 is normally OFF. Transistor 281 is switched on for 1.2 μs, though in practice it is only fully on for approximately 700 ns. This is enough time to charge the GM tube 220 to 550V. The GM tube 220 can be modelled as a 1.8 pF capacitor. Once charged, experiment shows that the tube 220 will retain its charge indefinitely, due to low leakage current through transistor 281, though the circuit is configured to recharge the tube 220 every 100 ms to ensure the GM tube 220 remains “primed”.

When an ionization event in the tube 220 occurs, the tube 220 discharges through capacitor 282 and biases transistor 283 (Q3) ON. This results in a short (less than 100 μs) active low pulse on the output of the circuit. When the pulse is detected, the MCU 290 waits for a predetermined period of time (in this embodiment 1 ms) to allow the tube 220 to quench. The MCU 290 then outputs the 1.2 μs signal to transistor 281 to restart the cycle of operation.

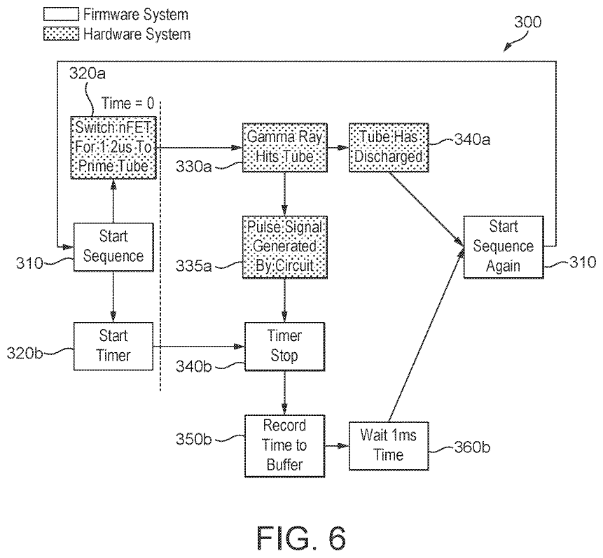

FIG. 6 illustrates the principles of a “time-to-first-count” methodology implemented using the apparatus of FIGS. 3 to 5. As in FIG. 2, the steps relating to hardware are provided with the suffix ‘a’ and the steps relating to firmware are provided with the suffix ‘b’.

In the present method, as explained above in detail, the GM tube is primed—charged to 550V—by connecting the cathode to 0V via an nFET for approximately 1.2 μs. Although in this example the “connection time” was 1.2 μs, it will be appreciated that the specific amount of time may be selected to be within a range that represents a very short time, i.e. that is less than the pulse width 360b.

In this embodiment, the sequence is started 310 by simultaneously priming the GM tube 320a and starting a timer 320b of the MCU 290. In other words, in this embodiment, the timer starts at the start of the recharge pulse. However, it will be appreciated that, in other embodiments, the counter may be started at the end of a recharge pulse. In other words, the timer start 320b may occur immediately at the end of the GM tube priming 320a.

An ionisation event occurs when an ionising radiation hits the GM tube 330a. This causes a pulse signal 335a to be generated within the circuit. This causes simultaneously the tube to be discharged instantly 340a and the timer to stop 340b. The time required to buffer the system is then recorded 350b and the next sequence is started again 310 after a pre-determined period of time selected for the apparatus 210 (for example 1 ms) (160b).

The present methodology and apparatus allows the implementation of a “time-to-first-count” approach, whilst addressing many of the associated disadvantages or limitations of the prior art.

As explained previously, the present inventors have developed systems and methods configured to process a counting output associated with a counting device such as a Geiger-Müller tube. This new approach allows a user to measure an event rate with quicker response times at a higher range. This may allow compliance with the requirements set out in the standards for dosimeters, even at very low count rates (e.g. when the count rates tends to zero) and/or upon a rapid step change from high to low count rates.

When calculating a “moving” or “rolling” average, the method comprises:
calculating a first time-to-count average value based on time-to-count values obtained for a number of events ‘n’ between events x₁ and xₙ;
measuring a time-to-count value associated with event xₙ₊₁; and
calculating a second time-to-count average value based on time-to-count values obtained for the number of events n between events x₂ and xₙ₊₁.

Thus, the second time-to-count average value, and any subsequent time-to-count average value calculated for a number of events n including any subsequent time-to-count value, can be considered a “rolling” average based on the latest ‘n’ number of events. An average count rate, e.g. a first average count rate and/or a second average count rate, may be calculated based on an associated time-to-count average value, e.g. the first time-to-count average value or the second time-to-count average value.

### “Dummy” Counts

If the time-to-count values increase significantly, e.g. compared to the time-to-count average value(s), the time required to detect an increase in the time-to-count average value over an epoch of interest, e.g. over the last ‘n’ number of events, may be significant. The present method addresses this problem by introducing “dummy counts” at a predetermined time interval “j” if no event has been registered after the predetermined time interval “j”.

In the present example, we consider starting the device at time t=0 and a list of stored time-to-count values [] to which a new time-to-count value is added each time a new event is registered for the purpose of averaging as described previously. If, after a specified time period j, no event has been registered, a “dummy” time-to-count value is inserted into the list given by ttc=t+j where ttc is the time-to-count value. Here, t=0 so ttc=j. Thus, the list now becomes [j]. If, following another amount of time j, no count is received, the list is added to again, this time the “dummy” value will be ttc=j+ttcₚᵣₑᵥᵢₒᵤₛ=2j. Thus, the list of values will be [j, 2j]. This process continues until a count is received.

In the present example, if we have a selected time interval “j” of 0.1 s, and the first count is received at 0.95 s, the list of-time-to-count values would be: [0.1, 0.2, 0.3, 0.4, 0.5, 0.6, 0.7, 0.8, 0.9, 0.95]. Once an actual (‘real’) time-to-count (ttc) value is measured, the device now has an “expected” ttc value which it will insert into the list after each time period j until either a new count is received or until the expected ttc value is passed without a count registered, in which case it will add the time j to it repeatedly until a count is detected. Thus, in the present example, if the second count is measured at 0.5 s, the list of values will be: [0.1, 0.2, 0.3, 0.4, . . . , 0.9, 0.95, 0.95, 0.95, 0.95, 0.95, 0.5, . . . ]. If the third count is measured at 0.76 s, then the list will be: [0.1, 0.2, 0.3, 0.4, . . . , 0.9, 0.95, 0.95, 0.95, 0.95, 0.95, 0.5, 0.5, 0.5, 0.5, 0.5, 0.5, 0.6, 0.7, 0.76, . . . ]. This process will continue until the list is full for the predetermined number of counts required to calculate the time-to-count average value.

An advantage of this method is that it can respond to a sudden drop of counts from high radiation fields to low radiation fields much more quickly than averaging without “dummy” counts. It will be understood that, when used in connection with a radiation measuring device, the use of “dummy counts” only affects calculation of the instantaneous (average) count rate, but does not affect the overall accumulated dose measured by the device and the “dummy” counts are not taken into account in calculating accumulated dose. Although the introduction of “dummy counts” introduces a level of noise into the calculations, e.g. into the calculated “time-to-count” average value, it will be understood that the level of error introduced is acceptable at lower count rates (in line with standard requirement), and is outweighed by the benefit of a much faster response to a drop in count rates.

### Smoothing Algorithm

The method may comprise processing the counting output using a smoothing algorithm. For example, the method may comprise using a Non-Linear Exponential Smoothing (‘NLES’) algorithm. The method may comprise applying an algorithm according to Formula (I)′:

$${y}_{n} = ( 1 - α ) \cdot {y}_{n - 1} + α \cdot {x}_{n} \qquad {( I )}^{′}$$

where y represents the filtered value, and
x is the rate derived from the calculated rolling average (e.g. the second time-to-count average value).

Advantageously, the value of α may change based on the magnitude of the error E determined according to Formula (II), interpolated between two values:

$$ε = \vert {log}_{10} {y}_{n - 1} - {log}_{10} {x}_{n} \vert . \qquad ( II )$$

The value may not be extrapolated, instead staying at the minimum or maximum value. For example:

$$if {ε}_{min} = 0.5 , {α}_{min} = 0.001 , {ε}_{max} = 2.9 , {α}_{max} = 0.99 ,$$

$$ε = 1 \to α = 0.207$$

$$ε = 2 \to α = 0.619$$

$$ε = 10 \to α = 0.99$$

Advantageously, there may be provided a plurality of filters. There may be provided two filters, e.g. a first filter for high count rate fields and a second filter for low count rate fields. If the raw count rate xₙ is equal to or greater than a first threshold (e.g. equal to or greater than two counts per second), the method may comprise applying the first filter. If the raw count rate xₙ is below the first threshold (e.g. below two counts per second), the method may comprise applying the second filter. Advantageously, this may allow a smooth reading to be obtained at high count fields, but allowing a quicker response to low count fields in response to smaller magnitude changes. Thus, in the present example:
For high count filter coefficients:

$${x}_{n} > 2 cps \to {ε}_{min} = 0.5 , {α}_{min} = 0.001 , {ε}_{max} = 2.9 , {α}_{max} = 0.99$$

For low count filter coefficients:

$${x}_{n} < 2 cps \to {ε}_{min} = 0.1 , {α}_{min} = 0.2 , {ε}_{max} = 2 , {α}_{max} = 0.99$$

1. A method of processing a counting output associated with a counting device, the method comprising:
(i) calculating a first time-to-count average value based on time-to-count values obtained for a number of events ‘n’ between events x₁ and xₙ;
(ii) measuring a time-to-count value associated with event xₙ₊₁; and
(iii) calculating a second time-to-count average value based on time-to-count values obtained for the number of events ‘n’ between events x₂ and xₙ₊₁.

2. A method according to claim 1, wherein, if no event has been registered after a predetermined time interval “j”, the method comprises (iv) introducing a “dummy” time-to-count value equal to “j” associated with event xₙ₊₁.

3. A method according to claim 2, comprising (v) introducing a “dummy” time-to-count value equal to “j” associated with each subsequent event, until a count or “real” event is measured or registered.

4. A method according to claim 1, wherein, when a count or “real” event is measured or registered for event xₘ (m>n and xₘ>j), the method comprises (vi) providing a time-to-count value corresponding to the measured time-to-count value associated with event xₘ.

5. A method according to claim 4, wherein the time-to-count value corresponding to the measured time-to-count value associated with event xₘ represents or defines an expected time-to-count value.

6. A method according to claim 5, wherein, if no event is registered after the predetermined time interval “j”, the method comprises (vii) introducing a “dummy” time-to-count value equal to the expected time-to-count value associated with event xₘ.

7. A method according to claim 6, wherein the method comprises repeating step (vii) until:
either a new count or “real” event is measured or registered; in which case the method may comprise (viii) providing a time-to-count value corresponding to the measured time-to-count value associated with the new count or “real” event;
or the expected time-to-count value has elapsed without a new count being measured or registered, in which case the method may comprise (ix) introducing a “dummy” time-to-count value equal to “j”.

8. A method according to claim 2, wherein the “dummy” time-to-count value “j” is about 1 ms-500 ms, optionally about 10 ms-200 ms, optionally about 50 ms to 150 ms, optionally about 100 ms.

9. A method according to claim 1, wherein the method comprises processing the counting output using a Non-Linear Exponential Smoothing ('NLES') algorithm.

10. A method according to claim 1, the method comprising calculating an average count rate, optionally a first average count rate and/or a second average count rate, based on an associated time-to-count average value, optionally the first time-to-count average value or the second time-to-count average value.

11. A method according to claim 10, comprising filtering the average count rate values.

12. A method according to claim 10, the method comprising applying an algorithm according to Formula (I):
$${S}_{n} = ( 1 / {t}_{n} - {S}_{n - 1} ) \times α ( \vert {Δ}_{n} \vert ) + {S}_{n - 1} . \qquad ( I )$$
where Sₙ is the smoothed count rate value calculated by the algorithm;
tₙ is the current time-to-count average value,
Sₙ₋₁ is the previously smoothed count rate value calculated by the algorithm;
$${Δ}_{n} = \vert {log}_{10} {S}_{n - 1} - {log}_{10} 1 / {x}_{n} \vert ;$$
$$and$$
$$α ( \vert {Δ}_{n} \vert ) = \{ \begin{matrix}{α}_{0} , for \vert {Δ}_{n} \vert \leq {Δ}_{0} \\ \vert {Δ}_{n} \vert − {Δ}_{0} / {Δ}_{1} − {Δ}_{0} \times ( {α}_{1} − {α}_{0} ) + {α}_{0} , for {Δ}_{0} \leq \vert {Δ}_{n} \vert \leq {Δ}_{1} \\ {α}_{1} , for \vert {Δ}_{n} \vert \geq {Δ}_{1}\end{matrix} .$$
wherein α₀ is a first filter applied when |Δₙ| is less than or equal to a first threshold Δ₀; and
α₁ is a second filter applied when |Δₙ| is equal to or greater than a second threshold Δ₁.

13. A method of processing a counting output associated with a counting device, the method comprising:
calculating a first time-to-count average value based on time-to-count values obtained for a number of events ‘n’ between events x₁n and xₙ;
measuring a time-to-count value associated with event xₙ₊₁;
calculating a second time-to-count average value based on time-to-count values obtained for the number of events n between events x₂ and xₙ₊₁; and
applying an algorithm according to Formula (I) to calculate a smoothed count rate Sₙ:
$${S}_{n} = ( 1 / {t}_{n} - {S}_{n - 1} ) \times α ( \vert {Δ}_{n} \vert ) + {S}_{n - 1} ) . \qquad ( I )$$
where Sₙ is the smoothed count rate value calculated by the algorithm;
tₙ is the second time-to-count average value,
Sₙ₋₁ is the previously smoothed count rate value calculated by the algorithm;
$${Δ}_{n} = \vert {log}_{10} {S}_{n - 1} - {log}_{10} 1 / {x}_{n} \vert ;$$
$$and$$
$$α ( \vert {Δ}_{n} \vert ) = \{ \begin{matrix}{α}_{0} , for \vert {Δ}_{n} \vert \leq {Δ}_{0} \\ \vert {Δ}_{n} \vert − {Δ}_{0} / {Δ}_{1} − {Δ}_{0} \times ( {α}_{1} − {α}_{0} ) + {α}_{0} , for {Δ}_{0} \leq \vert {Δ}_{n} \vert \leq {Δ}_{1} \\ {α}_{1} , for \vert {Δ}_{n} \vert \geq {Δ}_{1}\end{matrix} .$$
wherein α₀ is a first filter applied when |Δₙ| is less than or equal to a first threshold Δ₀; and
α₁ is a second filter applied when |Δₙ| is equal to or greater than a second threshold Δ₁.

14. A method according to claim 12, wherein the algorithm uses a first set of filters α₀ and α₁ under a first condition, optionally when the calculated count rate is equal to or greater than a first threshold, and wherein the algorithm uses second set of filters α′₀ and α′₁ under a second condition, optionally when the calculated count rate is less than the first threshold.

15. A method according to claim 13, the method comprising displaying a signal representative of the counting output.

16. A method according to claim 15, comprising displaying the smoothed count rate value.

17. A method according to claim 13, wherein the counting device comprises a Geiger-Müller tube.

18. (canceled)

19. A computer program comprising instructions which, when the program is executed by a computer, cause the computer to carry out a method of processing a counting output associated with a counting device, the method comprising:
(i) calculating a first time-to-count average value based on time-to-count values obtained for a number of events ‘n’ between events x1 and xn;
(ii) measuring a time-to-count value associated with event xn+1; and
(iii) calculating a second time-to-count average value based on time-to-count values obtained for the number of events ‘n’ between events x2 and xn+1.

20. A computer-readable medium comprising a computer program according to claim 19.
